(19) United States
(12) Patent Application Publication
(10) Pub. No.: US 2010/0191803 A1
(43) Pub. Date: Jul. 29, 2010

(54) server realizing network communication number service

(76) Inventor: Hanmin Yang, Guangdong (CN)

Correspondence Address: Na Xu, 6312 Seven Corners Center #324, Falls Church, VA, 22044, US

(21) Appl. No.: 12/665,867

(22) PCT Filed: Aug. 25, 2008
(86) PCT No.: PCT/CN2008/072124

§ 371 Date: Dec. 21, 2009

(30) Foreign Application Priority Data
Aug. 28, 2007 (CN) 200710076550.1

(51) Int. Cl. G06F 15/16

(52) U.S. Cl. 709/203

(57) ABSTRACT

A server realizing network communication number service is provided. Said server accepts inquiring appointed number. If this server manages said number practically, it will return an affirmation message to the inquirer. If this server does not manage said number practically, it will return a list of other servers, and advise the inquirer to further inquire these servers.

### TECHNOLOGY FIELD

Internet communication requires use of user identifications. A network communication number is an advanced user identification that can be used in communication applications such as internet email, real-time communication, network phone and the like.

### BACKGROUND

Internet communication requires use of user identifications. Numerical numbers, as a simple identification, have natural advantages in many situations, such as in internet phone systems. Described herein are network communication numbers as identification. Network communication numbers are numerical strings consisting of 0-9, such as 13012345, or numerical strings prefixed by area codes to be in forms such as +8613012345, 008613012345, CN13012345, or ABC13012345, et cetera.

Use of network communication numbers as identification presents a problem: what is the server that provides service? In comparison, we recognize its server from an email identification, also known as an email address, email: yanghm@headcll.com, that its server is mail.headcall.com. NSM (Network Short Message protocol) real-time communication employs user identification in the same format as email address to indicate the server address. For example, nsm: yanghm@headcall.com indicates that its main server is nsm.headcall.com and its backup server is nsm2.headcall.com.

Algorithms such as number segmentation or hash table can be used to calculate a server address corresponding to a network communication number. This approach only allows match between a network communication number and one or several preset servers, and therefore limits flexibility and dynamic expandability of the system.

How does one find the server that manages a network communication number? This is the first problem solved herein.

Various user identification methods have been employed in internet communications. A user may have multiple user identifications such as an email address and an nsm address. Can a single network communication number be used in existing and future internet communication services? This is the second problem solved herein.

### DETAILED DESCRIPTION

The first problem solved herein is how to find a server that manages a network communication number. We use the method that a domain name server (DNS) queries an IP address that corresponds to a domain name. A query is sent to a server. If this server manages the queried network communication number, then the query ends. Otherwise, this server returns a list of servers and recommends an inquirer continue the query with the listed servers.

The order of the listed servers can imply a level of connection between these servers and the queried network communication number. For example, the first server in the list is the server most likely to either manage the queried network communication number, or know which server manages the queried network communication number. Therefore, the inquirer should first continue the query with the first server in the list. In embodiments described herein below, we will explicitly indicate the level of connection between the servers and the queried network communication number by including number segments managed by each server in the returned list of servers.

Different application systems can have different methods of using network communication numbers. Some application systems use network communication numbers as user identifications in real-time communication. Affirmative information returned by a server contains real-time communication network address of a network communication number, such as its address in a TCP/IP network (IP:PORT). This is a server as recited in claim 2.

Some application systems do not require that a server returns the real-time communication network address for a network communication number, but only need to know that the server manages the network communication number. The server can have additional login and forwarding functions, or cooperate with another server that has login and forwarding functions. When forwarding messages, the server appends source addresses of the IP packets of the messages acquired from the TCP/IP transport protocol. The source addresses can be used for real-time communication and/or P2P (peer-to-peer) communication. This is a server as recited in claim 1.

The second problem solved herein is the use of a single network communication number in existing and future internet communication services. A server as recited in claim 3 is suitable for this purpose. A network communication number itself is not used as a real-time communication user identification. Instead, the server returns affirmative information that includes other real-time communication identifications corresponding to the network communication number, such as nsm identifications (nsm addresses), and optionally non-real-time communication identifications, such as email identifications (email addresses). The returned affirmative information can also include conventional telephone numbers and postal addresses.

Because a network communication number includes multiple communication identifications, it can be used in many communication systems. Such a communication system can acquire specific communication identification from a single network communication number.

Use of a network communication number to encapsulate user identifications allows the network communication number to remain unchanged in the event that the user specific communication identifications change. The network communication number is thus a relative stable form of user identity.

A method of realizing a server for network communication number service is described herein below.

We use numerical numbers (a string consisting of numbers from 0 to 9) as a network communication number. A number segment consists of numbers that have a common prefix. For example, a 130 number segment consists of all numbers in a form of 130xxxxxxx, i.e. all numbers with a prefix 130, for example, 13012345, 130123456, and 13012345678, et cetera.

A server receives a query of a specific network communication number. If the server manages this network communication number, it then returns affirmative information to an inquirer. We call this affirmative information number information, which includes other communication identifications such as nsm address, email address, cell phone numbers, and/or other network communication numbers. The affirmative information can also include instant message identifications or numbers such as MSN/qq/icq, and/or user account information such as a user name, a postal address, et cetera.

If the queried network communication number does not exist, the server returns an error message to the inquirer.

If the server does not manage the queried network communication number, it returns a list of other servers to the inquirer. The list also includes managed number segments of each server.

The network communication number server also accepts the following queries:

An address of servers that provide reciprocal backup with this server.

A shortcut number corresponding to the queried network communication number.

Time on this server.

Address information and managed number segments of other servers known by this server.

The above described number information may contain “other network communication numbers”, which can be used for applications to attempt to reach the “other network communication numbers” when the queried network communication number is unavailable (e.g. when a real-time communication identification of the queried communication numbers is offline).

When the server does not manage the queried network communication number, the returned list of servers has a format <server address>/<managed number segment>, such as

pbs.headcall.com/13

12.34.56.78/130

pbs.two.com/130123

The more closely the managed number segments of a server match the queried network communication number, the higher level of connection to the queried network communication number we consider the server has. For example, if the queried network communication number is 13012345, we should next query the server pbs.two.com because it is the server most likely to actually manage the number 13012345.

Each server manages one or more number segments. Management can be in the form of actual management such that the server can respond to queries in the managed number segments. Alternatively the management can be in a form such that the server cannot respond instantly to queries but rather returns a list of servers that may manage the queried number. If an inquirer sends a query that is out of the managed number segments of a server, the server returns a list of other servers known to the server to facilitate the query.

Some servers are referred to as root servers, which are designated in advance in a communication system. An inquirer can start a query to any one of the root servers. The query ends when the inquirer receives number information or an error message. Otherwise the query continues with servers in a returned list of servers.

A communication application may use a network communication number called the host number. One server is distinctive from other servers in that this server actually manages the host number. The application may cache the address of this server, and make future queries started from this server. Namely, this server becomes an entry server. If a queried network communication number is adjacent to the host number, this entry server probably also manages this queried network communication number. Otherwise, the entry server can provide the shortest query path.

In a robust system, servers have reciprocal backup. Therefore the application should cache both the entry server and its backup servers, so that when the entry server is offline, a query may continue on its backup servers. Network communication number servers provide the function that queries address information of their backup servers.

A communication application can use a short number to represent a long number. Network communication number servers can provide popular shortcut numbers, such as public emergency numbers in the internet phone systems. An application may query its entry server for configuration information of such shortcut numbers. The configuration information of shortcut numbers may depend on a queried network communication number, therefore a query of configuration information of shortcut numbers need to include the network communication number. For example, if an inquirer queries configuration information of shortcut numbers related to 13012345, a server can return:

110=12345110

120=12345120

If an inquirer queries configuration information of shortcut numbers related to 13067890, the server can return different information such as:

110=12346008

120=12346009

Time can be provided by network communication number servers to facilitate an application to adjust its time.

### BRIEF DESCRIPTION OF FIGURE

FIG. 1 is a block diagram of the system structure of the present invention.

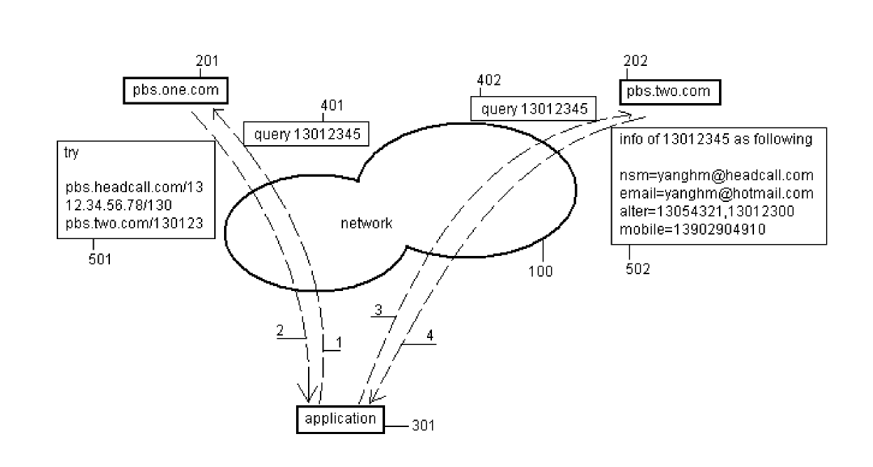

### DETAILED IMPLEMENTATION

Network communication number servers and an application are connected to a network 100.

The application 301 sends a query request 401 to the network communication number server pbs.one.com 201 and the queried network communication number is 13012345.

The network communication number server 201 does not actually manage the number 13012345. It returns a message 501 to instruct the application 301 what other servers to query. The message 501 specifies names of servers and their managed number segments.

The application 301 decides to first query pbs.two.com, and sends a query request 402 to the network communication number server 202. The queried network communication number is 13012345.

The network communication number server 202 actually manages the queried network communication number 13012345. It returns a message 502. The query ends. The message 502 includes an nsm address yanghm@headcall.com, an email address yanghm@hotmail.com, two other network communication numbers (alter) 13054321 and 13012300, and a cell phone number (mobile) 13902904910.

Detailed description and detailed implementation herein above is an explanation of the present invention. The present invention is not limited to the scope of such detailed description and detailed implementation. It will be appreciated that those skilled in the art will realize various simple deduction or alteration, which falls within the true spirit and scope of the invention.

1. (canceled)

2. (canceled)

3. (canceled)

4. (canceled)

5. A server responding to a query of a network communication number, wherein the server:
returns an affirmative message if the server manages the network communication number;
returns an error message if the network communication number does not exist; and
returns a list of other servers that possibly manage the network communication number, if the server does not manages the network communication number.
wherein the affirmative message comprises an nsm address and/or an email address.
